(19) United States
(12) Patent Application Publication
(10) Pub. No.: US 2026/0189575 A1
(43) Pub. Date: Jul. 2, 2026

(54) METHOD AND A SYSTEM FOR IDENTIFYING TARGET MESSAGES

(71) Applicant: GROUP-IB GLOBAL PRIVATE LIMITED, SINGAPORE (SG)

(72) Inventor: Boris ZVERKOV, Tula (RU)

(21) Appl. No.: 19/005,799

(22) Filed: Dec. 30, 2024

(30) Foreign Application Priority Data
Dec. 27, 2024 (SG) 10202404092X

(51) Int. Cl. H04L 9/40; G06N 5/01; G06N 20/00

(52) U.S. Cl. CPC H04L 63/1416; G06N 5/01; G06N 20/00

(57) ABSTRACT

Method and a system for identifying target messages are provided. The method comprises: during a first phase: training a plurality of prediction models to generate respective predictions of whether a given in-use message is a target one or not; generating, based on the respective predictions of the plurality prediction models, respective training consolidated probability vectors for a plurality of training messages; using the respective training consolidated probability vectors, training a decision tree model to determine whether the given in-use message is a target one or not; and during a second stage, following the first phase: using the plurality of prediction models and the decision tree model to classify in-use messages on online platforms; in response to determining that a given in-use message is a target message, causing execution of a remedial action.

### CROSS-REFERENCE TO RELATED APPLICATIONS

The present patent application claims priority from Singapore Patent Application Number 10202404092X filed on Dec. 27, 2024, an entirety of contents of which is incorporated herein by reference.

### FIELD

The present technology relates broadly to the field of cybersecurity; and in particular, to methods and systems for identifying target messages on online platforms.

### BACKGROUND

With growing popularity of online platforms, such as social networks, various forums, and messengers, intruders are now provided with a new space for plotting cybercrimes and propagating riotous statements. For example, the Arab Spring in Egypt started from the Facebook group called “We are all Khaled Said.” In addition to riotous statements, forums and messenger channels may be used to send malicious advertisements proposing to buy access to enterprise networks, databases, domain names. Also, such malicious messages (also referred to herein as “target messages”) can be for inviting contractors to preform illegal works.

Certain prior art approaches have been proposed to identify the target messages on online platforms.

U.S. Pat. No. 10,229,205-B1, issued on Mar. 12, 2019, assigned to Salesforce Inc., and entitled “MESSAGING SEARCH AND MANAGEMENT APPARATUSES, METHODS AND SYSTEMS,” discloses methods and systems for transforming message, ranking request inputs via system components into work graphs, ML structure input data, ML structure, ranking response outputs, obtaining a work graph generation request that includes group level access control data determining a set of metadata access control carrying messages, a set of users, a set of channels, and a set of topics with access control data corresponding to the group level access control data, calculating a user priority score for each of the other users, a channel priority score for each of the channels, and a topic priority score for each of the topics, from the perspective of each user, and generating work graph data structure may including, for each user, data regarding the calculated user priority scores, channel priority scores, and topic priority scores.

A courses for professionals in the machine learning entitled “Stacking Ensemble for Deep Learning Neural Networks in Python,” available at machinelearningmastery.com/stacking-ensemble-for-deep-learning-neural-networks/, discloses developing various meta-models including a stacking model using neural networks as a submodel and a scikit-learn classifier as the meta-learner and a stacking model where neural network sub-models are embedded in a larger stacking ensemble model for training and prediction.

An article entitled “A Stacking Ensemble Deep Learning Approach to Cancer Type Classification Based on TCGA Data,” authored by Mohammed et al., and published in Scientific Report in August 2021, discloses a stacking ensemble deep learning model based on one-dimensional convolutional neural network (1D-CNN) to perform a multi-class classification on the five common cancers among women based on RNASeq data.

### SUMMARY

It is an object of the present technology to ameliorate at least inconveniences associated with the prior art.

Non-limiting embodiments of the present technology are directed to analysis of messages and detection of target messages, a non-exhaustive list of examples of which is provided above, using a plurality of various machine-learning models.

More specifically, in accordance with a first broad aspect of the present technology, there is provided a computer-implemented method for identifying target messages. A target message including a malicious ad. The method comprises, during a first phase: acquiring, from online platforms, a plurality of training messages; generating, for a given training message of the plurality of training messages, a respective message vector; generating a training set of data including a plurality of training digital objects, a given one of which includes: (i) the respective message vector of the given training message; and (ii) a respective label representative of the given training message being one selected from the group consisting of: a target message; and a non-target message, feeding, to a given prediction model of a plurality prediction models, the given training digital object, thereby training the given prediction model to generate a respective prediction of whether a given in-use message is a target one or not; generating, based on respective predictions of the plurality prediction models, a respective training consolidated probability vector for the given training message of the plurality of training messages; using respective training consolidated probability vectors associated with the plurality of training messages, training a decision tree model to determine whether the given in-use message is a target one or not.. Further, during a second phase, following the first phase, the method comprises: acquiring, from the online platforms, the given in-use message; generating, for the given in-use message, a respective in-use message vector; feeding, the respective in-use message vector, to each prediction model of the plurality trained models, thereby causing each one of the plurality prediction models to generate a respective probability value of the given in-use message being a target message; generating, based on the respective probability values of the plurality prediction models, an in-use consolidated probability vector; feeding the in-use consolidated probability vector to the decision tree model, thereby causing the decision tree model to generate a final probability value of the given in-use message being a target message; in response to the final probability value being representative of the given in-use message being a target message, causing execution of a remedial action.

In some implementations of the method, the target message one selected from the group consisting of: a message about a sale or a purchase of illegal goods and services; a message advertising selling access to a private network; a message with proposals of illegal jobs; a message with proposals to participate in illegal actions; a message aimed at committing a crime; and a spam message.

In some implementations of the method, the generating the respective message vector comprises: replacing values of service fields of the given training message, hyperlinks, and emails with a respective predetermined value; tokenizing, comprising bringing all words in the message text to their initial form; generating a statistical metric representative of a frequency of occurrence of each word.

In some implementations of the method, the service fields comprise at least one selected from the group consisting of: a user identifier of an author of the given training message; a username of the author of the given training message; and a password of the author of the given training message.

In some implementations of the method, the generating the statistical metric comprises executing a Term Frequency Inverse Document Frequency (TF-IDF) algorithm.

In some implementations of the method, the generating the statistical metric comprises executing a Bidirectional Encoder Representations from Transformers (BERT) algorithm.

In some implementations of the method, after the generating the respective message vector, the method further comprises: clustering respective message vectors; in response to a given cluster including at least one training message that has been assigned the respective label being indicative of the at least one training message being a target one, determining all training messages of the given cluster as being target messages.

In some implementations of the method, the clustering the respective message vectors comprises executing a Hierarchical Density-Based Spatial Clustering of Applications with Noise (HDBSCAN) algorithm.

In some implementations of the method, each prediction model of the plurality of prediction models has a different architecture.

In some implementations of the method, the plurality models includes: a logistic regression model; a random forest model; a gradient boosting model; and a neural network.

In some implementations of the method, the training consolidated probability vector, along with the respective predictions of the plurality of prediction models, further comprises: values of a pairwise summation of the respective predictions; values of a triple summation of the respective predictions; and an arithmetic mean of the respective predictions.

In some implementations of the method, the causing the execution of the remedial action is executed in response to the final probability value exceeding a pre-determined threshold value.

In some implementations of the method, the remedial action comprises at least one selected from the group consisting of: submitting a complaint of an author the given in-use message to a respective customer support service; generating a warning notification about a cybersecurity incident; storing information of the given in-use message in a target message database; and generating a notification for displaying to an operator.

Further, in accordance with a second broad aspect of the present technology, there is provided a system for identifying target messages. A target message including a malicious ad. The system comprises at least one processor and non-transitory computer-readable medium, storing executable instructions, which, when executed by the at least one processor, cause the system to, during a first phase: acquire, from online platforms, a plurality of training messages; generate, for a given training message of the plurality of training messages, a respective message vector; generate a training set of data including a plurality of training digital objects, a given one of which includes: (i) the respective message vector of the given training message; and (ii) a respective label representative of the given training message being one selected from the group consisting of: a target message; and a non-target message, feed, to a given prediction model of a plurality prediction models, the given training digital object, thereby training the given prediction model to generate a respective prediction of whether a given in-use message is a target one or not; generate, based on respective predictions of the plurality prediction models, a respective training consolidated probability vector for the given training message of the plurality of training messages; use respective training consolidated probability vectors associated with the plurality of training messages, training a decision tree model to determine whether the given in-use message is a target one or not. Further, during a second phase, following the first phase, the executable instructions cause the system to: acquire, from the online platforms, the given in-use message; generate, for the given in-use message, a respective in-use message vector; feed, the respective in-use message vector, to each prediction model of the plurality trained models, thereby causing each one of the plurality prediction models to generate a respective probability value of the given in-use message being a target message; generate, based on the respective probability values of the plurality prediction models, an in-use consolidated probability vector; feed the in-use consolidated probability vector to the decision tree model, thereby causing the decision tree model to generate a final probability value of the given in-use message being a target message; in response to the final probability value being representative of the given in-use message being a target message, cause execution of a remedial action.

In the context of the present specification, unless expressly provided otherwise, a computer system may refer, but is not limited, to an “electronic device”, an “operation system”, a “system”, a “computer-based system”, a “controller unit”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, a “database” is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

### BRIEF DESCRIPTION OF THE DRAWINGS

For a better understanding of the non-limiting embodiments of the present technology, as well as other aspects and further features thereof, reference is made to the following description which is to be used in conjunction with the accompanying drawings, where:

FIG. 1 depicts a schematic diagram of an architecture of a hybrid machine-learning (ML) model that can be used in at least some non-limiting embodiments of the present technology;

FIG. 2 depicts a flow chart diagram of a training phase for training the hybrid ML model of FIG. 1 to identify target messages, in accordance with certain non-limiting embodiments of the present technology;

FIG. 3 depicts a flow chart diagram of an in-use phase for using the hybrid ML model of FIG. 1 to identify target messages, in accordance with certain non-limiting embodiments of the present technology;

FIG. 4 depicts a schematic diagram for a step of clustering training message vectors for executing the training phase of FIG. 2, in accordance with certain non-limiting embodiments of the present technology; and

FIG. 5 depicts a schematic diagram of a computing environment that can be used for executing the training and in-use phases of the hybrid ML model of FIG. 1, in accordance with certain non-limiting embodiments of the present technology.

### DETAILED DESCRIPTION

The following detailed description is provided to enable any one skilled in the art to implement and use the non-limiting embodiments of the present technology. Specific details are provided merely for descriptive purposes and to give insights into the present technology, and no was as a limitation. However, it would be apparent for the person skilled in the art that some of these specific details may not be necessary to implement certain non-limiting embodiments of the present technology. The descriptions of specific implementations are only provided as representative examples. Various modifications of these embodiments may become apparent to the person skilled in the art; the general principles defined in this document may be applied to other non-limiting embodiments and implementations without departing from the scope of the present technology.

Certain non-limiting embodiments of the present technology are directed to systems and methods to identifying targeted messages including malicious ads on online platforms, such as forums and messengers.

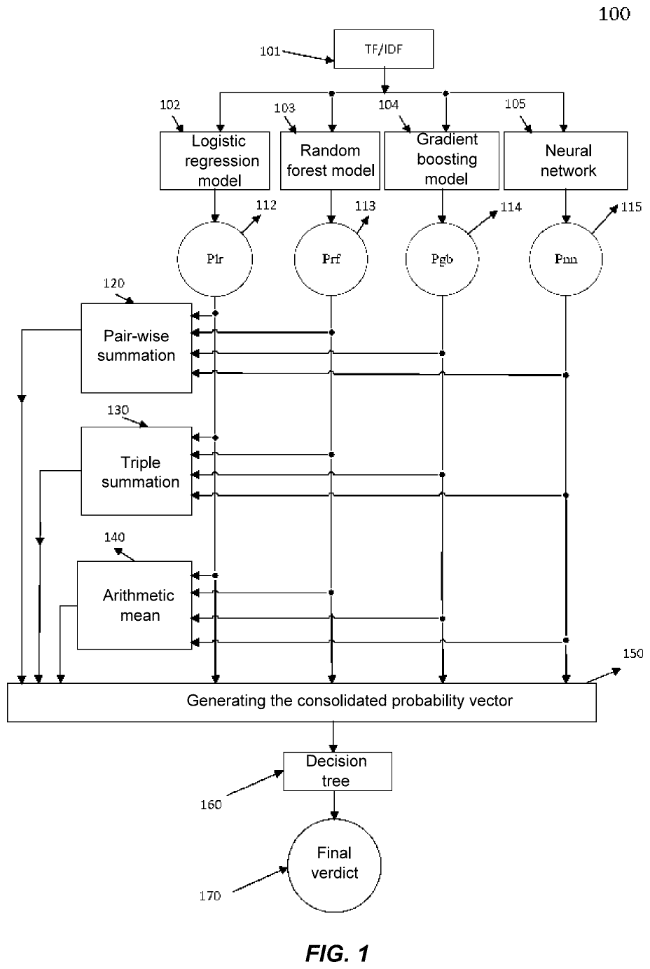

With the initial reference to FIG. 1, there is schematically depicted a hybrid machine-learning (ML) model 100 that is used for implementing of at least some non-limiting embodiments of the present technology. According to certain non-limiting embodiments of the present technology, the hybrid ML model 100 can be executed by a processor 501 of a computing environment 500.

As will become apparent from the description provided hereinabove, the computing environment 500 can be coupled to a communication network (not depicted). In some non-limiting embodiments of the present technology, the communication network is the Internet and/or an Intranet. How a communication link between the computing environment 500 and the communication network is implemented will depend, inter alia, on how the computing environment 500 is implemented, and may include, but is not limited to, a wire-based communication link and a wireless communication link (such as a Wi-Fi communication network link, a 3G/4G communication network link, and the like).

According to certain non-limiting embodiments of the present technology, first, the processor 501 can be configured to: (i) acquire, from at least one online platform, a plurality of messages; and (ii) convert each message of the plurality of messages into vectors. For conversion, in some non-limiting embodiments of the present technology, the processor 501 can be configured to execute a Term Frequency-Inverse Document Frequency (TF-IDF) algorithm 101. Then, in some non-limiting embodiments of the present technology, the processor 501 can be configured to alternately feed the message vectors to a plurality of pre-trained null-level ML models. According to certain non-limiting embodiments of the present technology, the plurality of null-level ML models comprises various ML models. In some non-limiting embodiments of the present technology, each ML model of the plurality of null-level ML models has a different architecture. For example, the plurality of null-level ML models can comprise: a first model 102 being a logistic regression model; a second model 103 being a random forest model; a third model 104 being a gradient boosting model; and a fourth model 105 being a neural network. A different number (such as five, ten, or fifty) and additional ML architectures for implementing the plurality of null-level ML models are envisioned without departing from the scope of the present technology. Also, in some non-limiting embodiments of the present technology, the plurality of null-level ML models can include at least two models having similar architectures.

According to certain non-limiting embodiments of the present technology, the plurality of null-level ML models is preliminarily trained based on training message vector to predict a probability that a given message is a target message. The training of the plurality of null-level ML models will be described in greater detail below.

Further, after the training, the plurality of null-level ML models is used for classifying input messages. More specifically, in some non-limiting embodiments of the present technology, the processor 501 can be configured to receive, from each ML model of the plurality of null-level ML models, a respective probability that a given message is a target message. As best seen from FIG. 1, the processor 501 can be configured to receive: a first probability Plr 112 from the first model 102, a second probability Prf 113 from the second model 103, a third probability Pgb 114 from the third model 104, and a fourth probability Pnn 115 from the fourth model 105.

Further, according to certain non-limiting embodiments of the present technology, based on the first, second, third, and fourth probabilities 112, 113, 114, 115, the processor 501 can be configured to generate a consolidated probability vector 150. To this end, the processor 501 can be configured to determine a pair-wise summation of the probabilities obtained from each of the first, second, third, and fourth models 102, 103, 104, 105, which is designated under numeral 120 in FIG. 1. Further, the processor 501 can be to generate respective triple summations of the first, second, third, and fourth probabilities 112, 113, 114, 115, which is designated under numeral 130 in FIG. 1. Also, in some non-limiting embodiments of the present technology, the processor 501 can be configured to generate an arithmetic mean 140 of the first, second, third, and fourth probabilities 112, 113, 114, 115.

Further, based on the results of the pair-wise summation 120, the triple summation 130, and arithmetic mean 140, the processor 501 can be configured to generate the consolidated probability vector 150. According to some non-limiting embodiments of the present technology, the processor 501 can be configured to feed the consolidated probability vector 150 to a decision tree model 160, that has been pre-trained to determine whether the given message is a target message based on training consolidated probability vectors. In response, the decision tree model 160 generates a final probability 170 of the given message being a target message.

The method of identifying target messages described herein includes two phases. The first phase is a training stage, during which the processor 501 can be configured to train the ML models mentioned above, that is, the first, second, third, and fourth models 102, 103, 104, and 105, as well as the decision tree model 160. The second phase is an in-use phase that follows after the training phase, during which the processor 501 can be configured to use the trained models for classifying input messages.

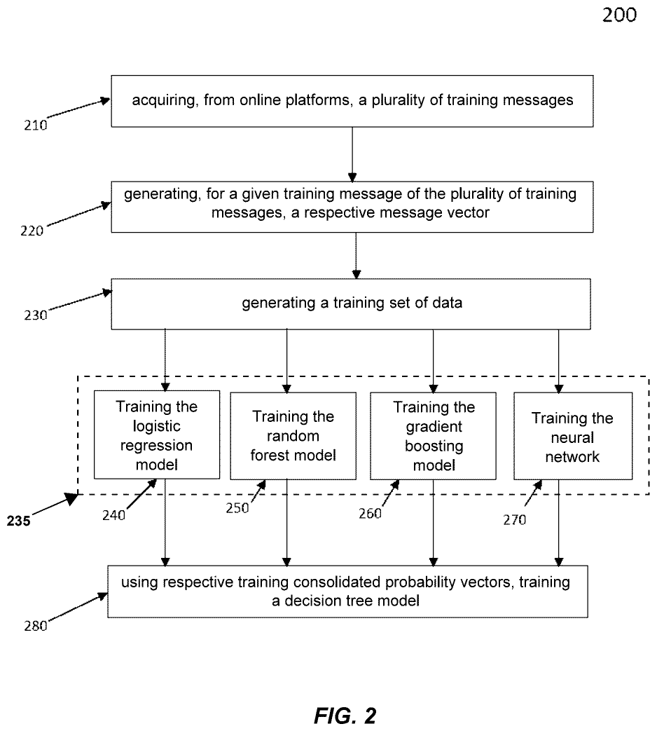

With reference to FIG. 2, there is depicted a flow chart diagram of a training phase 200 of the present method, in accordance with certain non-limiting embodiments of the present technology. The training phase 200 can be executed by the processor 501.

### Step 210: Acquiring, From Online Platforms, a Plurality of Training Messages

The training phase 200 commences at step 210 with the processor 501 being configured to receive, over the communication network, a plurality of training messages from various online platforms, including forums and messengers, for example. In some non-limiting embodiments of the present technology, each one of the plurality of training messages can be preliminarily assigned, or labelled, with a respective label representative of a given training messages being a target one or not. The respective label of each training message of the plurality of training messages will further be used for downstream classification tasks, as will be described below.

The preliminary labelling of the messages, i.e., dividing them into two groups: a group that comprises target messages (e.g., calls for illegal actions) and a group that does not comprise target messages, may be performed, e.g., with the involvement of human operators. Alternatively, the preliminary labelling may be performed by a system that is configured to classify messages into target and non-target messages, similar to the method described below.

In some non-limiting embodiments of the present technology, the processor 501 can be configured to store, such as in a storage of the computing environment 500 the received labelled training messages.

The training phase 200 hence advances to step 220.

### Step 220: Generating, for a Given Training Message of the Plurality of Training Messages, a Respective Message Vector

At step 220, according to certain non-limiting embodiments of the present technology, the processor 501 can be configured to generate, for each training message of the plurality of training messages, a respective message vector. To that end, according to certain non-limiting embodiments of the present technology, the processor 501 can be configured for masking, tokenizing, and calculating statistical metrics for each one of the plurality of training messages.

According to certain non-limiting embodiments of the present technology, the masking comprises replacing values of service fields of the given training message, such as such as user ID (an identifier of a message author), user name (his/her nickname), password; hyperlinks (URI, URL) and email addresses, with a respective pre-determined value.

For example, the processor 501 can be configured to use: (i) the respective predetermined value of 00 to replace an actual value 14 in the user ID service field in the given training message, (ii) the respective predetermined value of USERNAME to replace an actual value Sam_Buddy in the user name service field of the given training message, etc. Similarly, links to external resources may be replaced with a predetermined line such as “HTTP_URL”, while links to postal addresses may be replaced with another predetermined line “EMAIL@LINK”. To execute these actions, in some non-limiting embodiments of the present technology, the processor 501 can be configured to use preliminarily prepared scripts that insert predetermined values and lines into the respective given fields of the given training message.

Further, in some non-limiting embodiments of the present technology, the processor 501 can be configured to tokenize the given training message. By doing so, the processor 501 can be configured to analyze a text of the given training message to convert all words thereof to their respective initial forms. For example, the word “go” is the initial form of the form “is going,” expressed by two words; the word “want” is the initial form of the form “wanted,” expressed by one word. In some non-limiting embodiments of the present technology, for tokenizing the given training message, the processor 501 can be configured to execute a morphological analyzer (software module) pymorphy2.

Further, in some non-limiting embodiments of the present technology, the processor 501 can be configured to determine, for the given training message, the statistical metrics, such as TF-IDF, that is used for evaluation of importance of a given word in a context of a respective document. By doing so, the processor 501 can be configured to obtain a numeric value representative of popularity of a given word on a given online platform, such a forum or in the messenger channel. The determined TF-IDF values allow presenting the given training message as a respective numeric vectors, values of which comprise TF-IDF values for the words in the given training message.

In other non-limiting embodiments of the present technology, to generate the respective numeric vectors for the training messages, the processor 501 can be configured to execute a pre-trained Bidirectional Encoder Representations from Transformers (BERT) algorithm, as described in an article entitled “BERT: Pre-training of Deep Bidirectional Transformers for Language Understanding” by Devlin et al., the content of which is incorporated herein by reference in its entirety.

The training phase 200 hence advances to step 230.

### Step 230: Generating a Training Set of Data

At step 230, according to certain non-limiting embodiments of the present technology, the processor 501 can be configured to generate a training set of data for training the plurality of null-level ML models and the decision tree model 160. To this end, firstly, the processor 501 can be configured to cluster the respective vectors of the plurality of training messages, using, for example, a Hierarchical Density-Based Spatial Clustering of Applications with Noise (HDBSCAN) algorithm.

Further, the processor 501 can be configured to match the determined clusters to respective labels of the plurality of training messages, i.e., each cluster is “dyed” depending on whether it comprises at least one target message. Since all training messages that constitute the training sample have been preliminarily labelled with the respective label indicative of whether the given training message is a target message or not, the above-mentioned “dying” of the clusters may be performed by means of a preliminarily prepared script that checks whether each cluster comprises at least one target message.

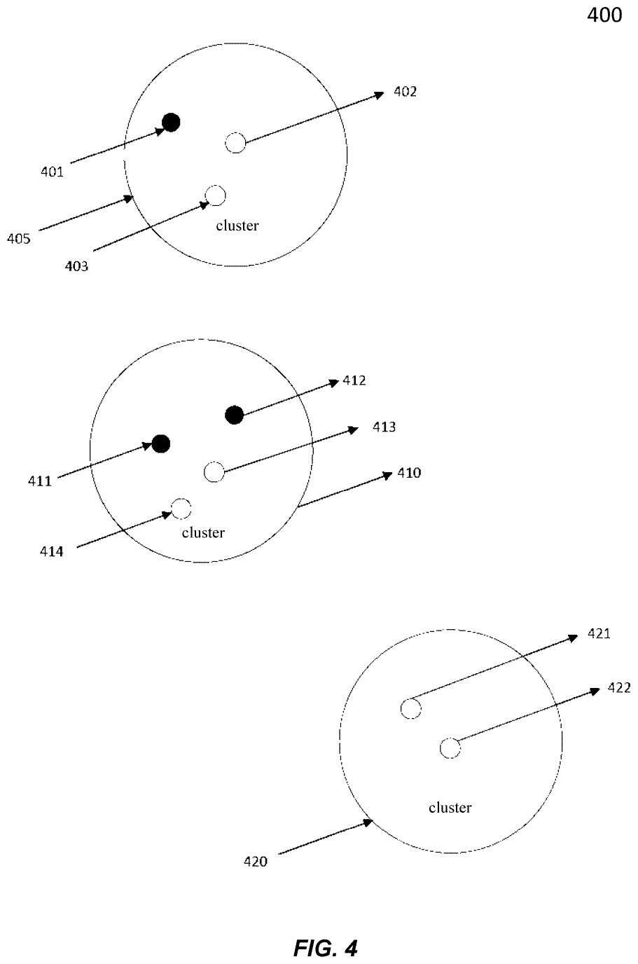

With reference to FIG. 4, there is depicted a schematic diagram of a step for preparing the training sample, in accordance with certain non-limiting embodiments of the present technology. As it can be appreciated, the processor 501 can be configured to cluster: (1) target training messages 401, 411, 412, e.g., messages about selling access to an enterprise network, as well as (2) non-target training messages 402, 403, 413, 414, 421, 422, into three clusters: a first cluster 405, a second cluster 410, and a third cluster 420 using the HDBSCAN algorithm.

At the “dying” step, the processor 501 can be configured to label the first and second clusters 405, 410, including the target messages 401, 411, 412, as being target clusters. Thus, all other training messages 402, 403, 413, 414, having vectors having fallen in the first and second clusters 405, 410, will also be marked as target messages. On the other hand, the training messages 421, 422 having vectors that fell in the third cluster 420, identified as non-target, will be considered non-target messages.

Further, in some non-limiting embodiments of the present technology, the processor 501 can be configured to store all words of the plurality of training messages in a glossary. The glossary is compiled such that 25% thereof consist of words, for which it is preliminarily known that they are representative of target messages (e.g., the words “sale” and “access” are considered representative of target messages in the context of the present examples of the target messages being about selling access to the enterprise network), and 75% thereof consist of words that are popular on a given online platform. The processor 501 can be configured to save the so generated glossary.

Further, the processor 501 can be configured to use the glossary to generate the vectors of the training set of data. More specifically, instead of building a given vector based on all the words of the given training message, the processor 501 can be configured to generate the given vector based on the words that are present in the glossary. This approach allows considering the words that are only comprised in a target class in a better way, and, thus, to increase the quality of training that is performed at the next steps.

Thus, according to certain non-limiting embodiments of the present technology, the processor 501 can be configured to generate the training set of data including a plurality of training digital objects, a given one of which includes: (i) the respective message vector of the given training message; and (ii) a respective label representative of the given training message being one selected from the group consisting of: a target message; and a non-target message.

The training phase 200 hence advances to step 235.

### Step 235: Feeding, to a Given Prediction Model of a Plurality Prediction Models, the Given Training Digital Object, Thereby Training the Given Prediction Model to Generate a Respective Prediction of Determine Whether a Given In-Use Message is a Target One or Not

At step 235, according to certain non-limiting embodiments of the present technology, using the training set of data generated at step 230, the processor 501 can be configured to train each one of the plurality of null-level ML models. To that end, step 235 is broken down into four sub-steps: sub-step 240 for training the first model 102, sub-step 250 for training the second model 103, sub-step 260 for training the third model 104, and sub-step 270 for training the fourth model 105.

It must be expressly understood that sub-steps 240, 250, 260, and 270 may be performed in any order, including a random order, a sequential order, or in parallel. Moreover, in some non-limiting embodiments of the present technology, at least some of the sub-steps 240, 250, 260, and 270 can be executed in parallel, whereas the others can be executed sequentially.

Thus, at sub-step 240, the processor 501 can be configured to feed each one of the plurality of training digital objects to the first model 102 of the plurality of null-level ML models. Further, by optimizing, at each training iteration a respective loss function (such as a cross-entropy loss function or a mean squared error loss function, for example), the processor 501 can be configured to train the first model 102 to predict the first probability Plr 112 that the given message is a target message. To train the first model 102, the processor 501 can be configured to use, for example, a stochastic gradient descent method. After training, the processor 501 can be configured to save the trained first model 102 in the storage 503. At this point, sub-step 240 terminates, and step 235 proceeds to sub-step 250.

Further, at sub-step 250, the processor 501 can be configured to feed each one of the plurality of training digital objects to the second model 103 of the plurality of null-level ML models. Further, by optimizing, at each training iteration a respective loss function, the processor 501 can be configured to train the second model 103 to predict the second probability Prf 113 that the given message is a target message. For example, in those embodiments where the second model 103 is a random forest, the processor 501 can be configured to use a bootstrapping algorithm and building a plurality of independent decision trees based on the Gini coefficient. After training, the processor 501 can be configured to save the trained second model 103 in the storage 503. At this point, sub-step 250 terminates, and step 235 proceeds to sub-step 260.

At sub-step 260, the processor 501 can be configured to feed each one of the plurality of training digital objects to the third model 104 of the plurality of null-level ML models. Further, by optimizing, at each training iteration a respective loss function, the processor 501 can be configured to train the third model 104 to predict the third probability Pgb 114 that the given message is a target message. For example, in those embodiments where the third model 104 is a gradient-boosted decision tree-based model, the processor 501 can be configured for incremental training of decision trees, where each new tree corrects prediction errors of previous trees using the gradient descent in order to minimize the respective loss function. After training, the processor 501 can be configured to save the trained third model 104 in the storage 503. At this point, sub-step 260 terminates, and step 235 proceeds to sub-step 270.

At sub-step 270, the processor 501 can be configured to feed each one of the plurality of training digital objects to the fourth model 105 of the plurality of null-level ML models. Further, by optimizing, at each training iteration a respective loss function, the processor 501 can be configured to train the fourth model 105 to predict the fourth probability Pnn 115 that the given message is a target message. For example, in those embodiments where the fourth model 104 is a neural network, the processor 501 can be configured to use a backpropagation algorithm. After training, the processor 501 can be configured to save the trained fourth model 105 in the storage 503. At this point, sub-step 270 terminates, and so does step 235.

The training phase 200 hence advances to step 280.

### Step 280: Generating, Based on Respective Predictions of the Plurality Prediction Models, a Respective Training Consolidated Probability Vector for the Given Training Message of the Plurality of Training Messages; Using the Respective Training Consolidated Probability Vectors Associated with the Plurality of Training Messages, Training a Decision Tree Model to Determine Whether the Given In-Use Message is a Target One or Not

At step 280, according to certain non-limiting embodiments of the present technology, the processor 501 can be configured to generate, based on intermediate instances of the first, second, third, and fourth probabilities 112, 113, 114, and 115, generate the training consolidated probability vector, similar to the consolidated probability vector 150, mentioned above with reference to FIG. 1. Further, using the training consolidated probability vectors, the processor 501 can be configured to train the decision tree model 160 to generate the final probability 170 of the given message being target.

To generate a given training consolidated probability vector (not depicted), first, the processor 501 can be configured to determine pair-wise summations of the intermediate instances of the first, second, third, and fourth probabilities 112, 113, 114, and 115 at the respective training iteration of training the plurality of null-level ML models, as mentioned above with reference to FIG. 1 at 120. More specifically, the processor 501 can be configured to determine following sums:

$$P 01 = Plr + Prf , \qquad ( 1 )$$

$$P 02 = Plr + Pgb ,$$

$$P 03 = Plr + Pnn ,$$

$$P 04 = Prf + Pgb ,$$

$$P 05 = Prf + Pnn , and$$

$$P 06 = Pgb + Pnn .$$

Further, using the same intermediate instances of the first, second, third, and fourth probabilities 112, 113, 114, and 115, the processor 501 can be configured to determine triple summations, as described above with reference to FIG. 1 at 130:

$$P 07 = Plr + Prf + Pgb , \qquad ( 2 )$$

$$P 08 = Plr + Prf + Pnn ,$$

$$P 09 = Plr + Pgb + Pnn , and$$

$$P 10 = Prf + Pgb + Pnn .$$

In some non-limiting embodiments of the present technology, the processor 501 can further be configured to determine the arithmetic mean 140 of all the probabilities obtained from each of the first, second, third, and fourth models 102, 103, 104, 105, according to the following formula:

$$P 11 = 0.25 * ( Plr + Prf + Pgb + Pnn ) . \qquad ( 3 )$$

Further, the processor 501 can be configured to use first, second, third, and fourth probabilities 112, 113, 114, and 115 as well as all the values determined according to Equations (1), (2), (3) for generating the given training consolidated probability vector for the given training message. In some non-limiting embodiments of the present technology, to generate the given training consolidated probability vector, the processor 501 can be configured to combine these values. For example, the resulting training consolidated probability vector can have the following look:

$$\{ Plr , Prf , Pgb , Pnn , P 01 , P 02 , P 03 , P 04 , P 05 , P 06 , P 07 , P 08 , P 09 , P 10 , P 11 \} . \qquad ( 4 )$$

Similarly, the processor 501 can be configured to generate the respective consolidated probability vector for each training message of the plurality of training messages.

Further, according to certain non-limiting embodiments of the present technology, for training the decision tree model 160, the processor 501 can be configured to generate a second training set of data, including a second plurality of training digital objects, a given one which comprises: (1) the given training consolidated probability vector associated with the given training message; and (2) the respective label indicative of whether the given message is a target message or not. Based on the second plurality of training digital objects, the processor 501 can be configured to generate a decision tree model 160.

More specifically, to generate the decision tree model 160, the processor 501 can be configured to determine which element of the given training consolidated probability vector should be taken for splitting a respective branch of the decision tree model 160 to ensure an optimal data distribution and that each leave of the decision tree model 160 comprises messages of only one class.

The processor 501 can be configured to iteratively train the decision tree model 160 by passing therethrough the second plurality of training digital objects until a predetermined stopping criterion is reached. For example, it may be a number of tree branches, a maximum limited depth, etc. Alternatively, the method may be repeated until the entire second training set of data is divided with a predetermined precision level.

After training, the processor 501 can be configured to save the decision tree model 160 in the storage 503.

The training phase 200 thus terminates.

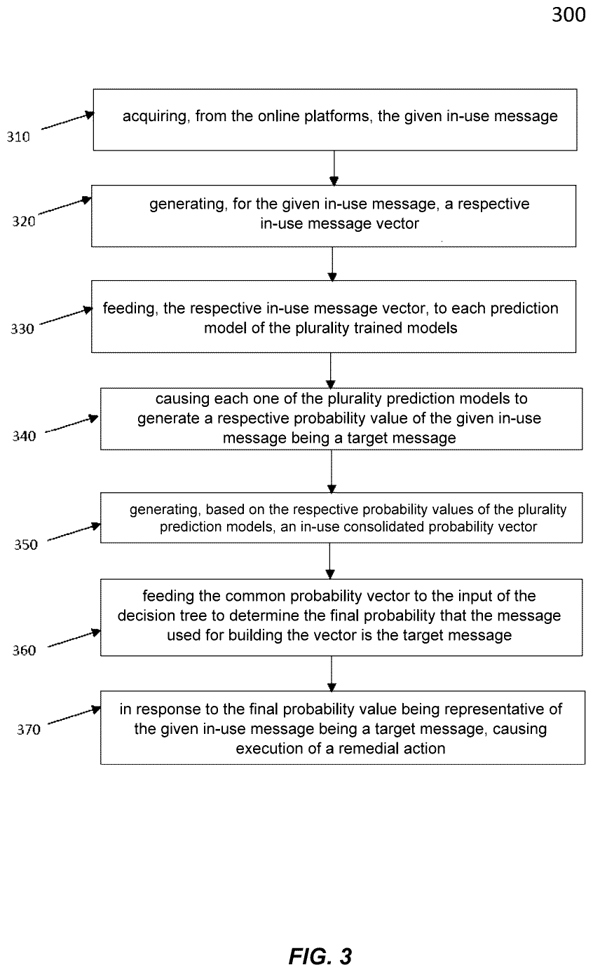

After executing the training phase 200 of the present method, the processor 501 can be configured to use the so trained models to identify target messages by executing an in-use phase 300, a flow chart diagram of which is depicted in FIG. 3, according to certain non-limiting embodiments of the present technology. Similar to the training phase 200, the in-use phase 300 can be executed by the processor 501.

### Step 310: Acquiring, from the Online Platforms, the Given In-Use Message

The in-use phase 300 starts at step 310 that comprises the processor 501 receiving a given in-use message from one of the online platforms mentioned above, such as messengers and forums.

For example, in one of embodiments of the disclosed solution, the processor 501 can be configured to receive the given in-use message from the Telegram™ messenger. To this end, various accounts are preliminarily created, and each of the accounts joins various groups. A similar approach is used, since this messenger has a limitation in terms of a number of groups that a single account may join to, i.e., up to 500 groups. When processing the messages of the messengers that do not have such limitations, this optional step is omitted.

After joining a given group, the processor 501 can be configured to execute a predetermined script (for example, in Python) to receive all new messages of the given group, while requesting history messages (published in the group before joining) from time to time (for example, periodically) via the command “Get history messages” that may be implemented by means of a standard messenger API. By doing so, the processor 501 can be configured to receive in-use messages from the plurality of groups, channels, forums, etc., are received. After obtaining the given in-use message as mentioned above, the processor 501 can be configured to save in the storage 503.

The in-use phase 300 hence advances to step 320.

### Step 320: Generating, for the Given In-Use Message, a Respective In-Use Message Vector

At step 320, according to certain non-limiting embodiments of the present technology, the processor 501 can be configured to generate, for the given in-use message, a respective in-use message vector. The processor 501 can be configured to generate the respective in-use message vector in a similar manner to generating the respective message vector at step 220 of the training phase 200.

The in-use phase 300 hence advances to step 330.

### Step 330: Feeding, the Respective In-Use Message Vector, to Each Prediction Model of the Plurality Trained Models

At step 330, the processor 501 can be configured to feed, to each one of the plurality of null-level ML models, the respective in-use message vector associated with the given in-use message received at step 310. In other words, in the present example, the processor 501 can be configured to feed the respective in-use message vector to the first, second, third, and fourth models 102, 103, 104, 105.

The in-use phase 300 hence advances to step 340.

### Step 340: Causing Each One of the Plurality Prediction Models to Generate a Respective Probability Value of the Given In-Use Message Being a Target Message

At step 340, the processor 501 can be configured to receive, from each one of the plurality of null-level ML models, the respective probability values that the given in-use message is a target message. The plurality of null-level ML models were configured to generate the respective probability values in response to receiving the respective in-use message vector.

More specifically, the first model 102 will generate an in-use instance of the first probability 112 of the given in-use message being a target one. Similarly, the second, third, and fourth models 103, 104, and 105 will generate respective in-use instances of the second, third, and fourth probabilities 113, 114, and 115, respectively, that the given in-use message is a target one.

Further, the processor 501 can be configured to store the so generated in-use instances of the first, second, third, and fourth probabilities 112, 113, 114, and 115 in the storage 503.

The in-use phase 300 hence advances to step 350.

### Step 350: Generating, Based on the Respective Probability Values of the Plurality Prediction Models, an In-Use Consolidated Probability Vector

At step 350, according to certain non-limiting embodiments of the present technology, the processor 501 can be configured to generate, based on the first, second, third, and fourth probabilities 112, 113, 114, and 115 obtained at step 340, an in-use consolidated probability vector (not depicted), similar to the consolidated probability vector 150. The processor 501 can be configured to generate the in-use consolidated probability vector similar to generating the given training consolidated probability vector as described above at step 280 of the training phase 200. Further, the processor 501 can be configured to store the in-use consolidated probability vector in the storage 503.

The in-use phase 300 hence advances to step 360.

### Step 360: Feeding the Common Probability Vector to the Input of the Decision Tree to Determine the Final Probability that the Message Used for Building the Vector is the Target Message

At step 360, the processor 501 can be configured to feed the in-use consolidated probability vector to the decision tree model 160 trained during the training phase 200.

After processing of the in-use consolidated probability vector, the decision tree model 160 generates the final probability 170 for the given in-use message. Based on the final probability 170, the processor 501 can be configured to determine whether the given in-use message is a target message. To do so, the processor 501 can be configured to determine whether the final probability 170 exceeds a predetermined probability threshold. For example, if the final probability 170 is a positive value that belongs to a range from 0 to 1, then in response to the final probability 170 exceeding the predetermined probability threshold being, for example, 0.73, the processor 501 can be configured to determine that the given in-use message is a target message that is associated with a malicious ad mentioned above.

In another example, the final probability 170 may be a binary variable that takes TRUE and FALSE values. In this case, in response to the final probability 170 having the TRUE value the processor 501 can be configured to determine that the given in-use message is a target message.

In response that the given in-use message received at the step 310 is not a target message, the in-use phase 300 will loop back to step 310 for receiving another in-use message.

The in-use phase 300 hence advances to step 370.

### Step 370: In Response to the Final Probability Value Being Representative of the Given In-Use Message Being a Target Message, Causing Execution of a Remedial Action

At step 370, in response the given in-use message received at the step 310 being a target message, the processor 501 can be configured to execute one or more remedial actions. According to certain non-limiting embodiments of the present technology, remedial actions can include at least:
submitting a complaint of an author the given in-use message to a respective customer support service;
generating a warning notification about a cybersecurity incident;
storing information of the given in-use message in a target message database; and
generating a notification for displaying to an operator.

The in-use phase 300 hence terminates, and so does the present method for identifying target messages.

### Computing Environment

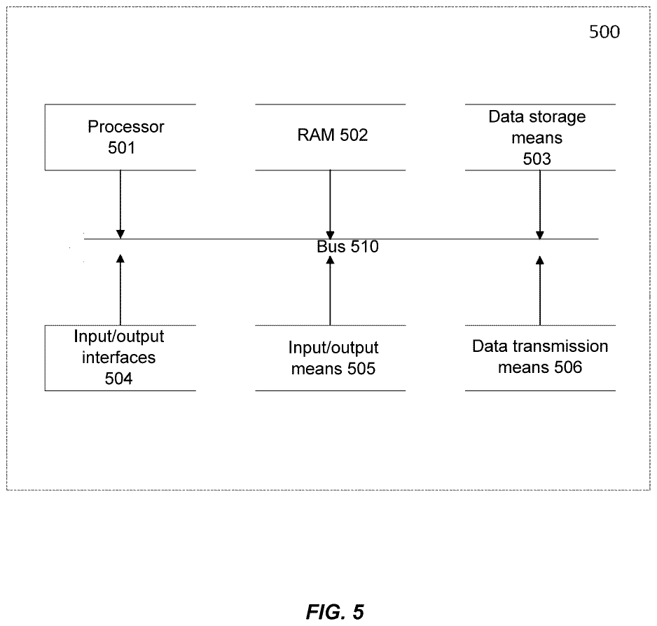

With reference to FIG. 5, there is depicted an example functional diagram of the computing environment 500 configurable to implement certain non-limiting embodiments of the present technology including the training and in-use phases 200, 300 of the present method, described above.

In some non-limiting embodiments of the present technology, the computing environment 500 may include: the processor 501 comprising one or more central processing units (CPUs), at least one non-transitory computer-readable memory 502 (RAM), a storage 503, input/output interfaces 504, input/output means 505, data communication means 506.

According to some non-limiting embodiments of the present technology, the processor 501 may be configured to execute specific program instructions the computations as required for the computing environment 500 to function properly or to ensure the functioning of one or more of its components. The processor 501 may further be configured to execute specific machine-readable instructions stored in the at least one non-transitory computer-readable memory 502, for example, those causing the computing environment 500 to execute the training and in-use phases 200, 300 of the present method, as an example.

In some non-limiting embodiments of the present technology, the machine-readable instructions representative of software components of disclosed systems may be implemented using any programming language or scripts, such as C, C++, C#, Java, JavaScript, VBScript, Macromedia Cold Fusion, COBOL, Microsoft Active Server Pages, Assembly, Perl, PHP, AWK, Python, Visual Basic, SQL Stored Procedures, PL/SQL, any UNIX shell scrips or XML. Various algorithms are implemented with any combination of the data structures, objects, processes, procedures and other software elements.

The at least one non-transitory computer-readable memory 502 may be implemented as RAM and contains the necessary program logic to provide the requisite functionality.

The storage 503 may be implemented as at least one of an HDD drive, an SSD drive, a RAID array, a network storage, a flash memory, an optical drive (such as CD, DVD, MD, Blu-ray), etc. The storage 503 may be configured for long-term storage of various data, e.g., the aforementioned documents with user data sets, databases with the time intervals measured for each user, user IDs, etc.

The input/output interfaces 504 may comprise various interfaces, such as at least one of USB, RS232, RJ45, LPT, COM, HDMI, PS/2, Lightning, FireWire, etc.

The input/output means 505 may include at least one of a keyboard, a joystick, a (touchscreen) display, a projector, a touchpad, a mouse, a trackball, a stylus, speakers, a microphone, and the like. A communication link between each one of the input/output means 505 can be wired (for example, connecting the keyboard via a PS/2 or USB port on the chassis of the desktop PC) or wireless (for example, via a wireless link, e.g., radio link, to the base station which is directly connected to the PC, e.g., to a USB port).

The data communication means 506 may be selected based on a particular implementation of a network, to which the computing environment 500 can have access, and may comprise at least one of: an Ethernet card, a WLAN/Wi-Fi adapter, a Bluetooth adapter, a BLE adapter, an NFC adapter, an IrDa, a RFID adapter, a GSM modem, and the like. As such, the connectivity hardware 504 may be configured for wired and wireless data transmission, via one of a WAN, a PAN, a LAN, an Intranet, the Internet, a WLAN, a WMAN, or a GSM network, as an example.

These and other components of the computing device 500 may be linked together using a common data bus 510.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to provide certain examples of implementation of the non-limiting embodiments of the present technology rather than to be limiting. The scope of the present technology is therefore intended to be limited solely by the scope of the appended claims.

1. A computer-implemented method for identifying target messages, a target message including a malicious ad, the method comprising:
during a first phase:
acquiring, from online platforms, a plurality of training messages;
generating, for a given training message of the plurality of training messages, a respective message vector;
generating a training set of data including a plurality of training digital objects, a given one of which includes: (i) the respective message vector of the given training message; and (ii) a respective label representative of the given training message being one selected from the group consisting of: a target message; and a non-target message;
feeding, to a given prediction model of a plurality prediction models, the given training digital object, thereby training the given prediction model to generate a respective prediction of whether a given in-use message is a target one or not;
generating, based on respective predictions of the plurality prediction models, a respective training consolidated probability vector for the given training message of the plurality of training messages;
using respective training consolidated probability vectors associated with the plurality of training messages, training a decision tree model to determine whether the given in-use message is a target one or not;
during a second phase, following the first phase:
acquiring, from the online platforms, the given in-use message;
generating, for the given in-use message, a respective in-use message vector;
feeding, the respective in-use message vector, to each prediction model of the plurality trained models, thereby causing each one of the plurality prediction models to generate a respective probability value of the given in-use message being a target message;
generating, based on the respective probability values of the plurality prediction models, an in-use consolidated probability vector;
feeding the in-use consolidated probability vector to the decision tree model, thereby causing the decision tree model to generate a final probability value of the given in-use message being a target message;
in response to the final probability value being representative of the given in-use message being a target message, causing execution of a remedial action.

2. The method of claim 1, wherein the target message one selected from the group consisting of:
a message about a sale or a purchase of illegal goods and services;
a message advertising selling access to a private network;
a message with proposals of illegal jobs;
a message with proposals to participate in illegal actions;
a message aimed at committing a crime; and
a spam message.

3. The method of claim 1, wherein the generating the respective message vector comprises:
replacing values of service fields of the given training message, hyperlinks, and emails with a respective predetermined value;
tokenizing, comprising bringing all words in the message text to their initial form;
generating a statistical metric representative of a frequency of occurrence of each word.

4. The method of claim 3, wherein the service fields comprise at least one selected from the group consisting of:
a user identifier of an author of the given training message;
a username of the author of the given training message; and
a password of the author of the given training message.

5. The method of claim 3, wherein the generating the statistical metric comprises executing a Term Frequency Inverse Document Frequency (TF/IDF) algorithm.

6. The method of claim 3, wherein the generating the statistical metric comprises executing a Bidirectional Encoder Representations from Transformers (BERT) algorithm.

7. The method of claim 1, wherein after the generating the respective message vector, the method further comprises:
clustering respective message vectors;
in response to a given cluster including at least one training message that has been assigned the respective label being indicative of the at least one training message being a target one, determining all training messages of the given cluster as being target messages.

8. The method of claim 7, wherein the clustering the respective message vectors comprises executing a Hierarchical Density-Based Spatial Clustering of Applications with Noise (HDBSCAN) algorithm.

9. The method of claim 1, wherein each prediction model of the plurality of prediction models has a different architecture.

10. The method of claim 9, wherein the plurality models includes:
a logistic regression model;
a random forest model;
a gradient boosting model; and
a neural network.

11. The method of claim 1, wherein the training consolidated probability vector, along with the respective predictions of the plurality of prediction models, further comprises:
values of a pairwise summation of the respective predictions;
values of a triple summation of the respective predictions; and
an arithmetic mean of the respective predictions.

12. The method of claim 1, wherein the causing the execution of the remedial action is executed in response to the final probability value exceeding a pre-determined threshold value.

13. The method of claim 1, wherein the remedial action comprises at least one selected from the group consisting of:
submitting a complaint of an author the given in-use message to a respective customer support service;
generating a warning notification about a cybersecurity incident;
storing information of the given in-use message in a target message database; and
generating a notification for displaying to an operator.

14. A system for identifying target messages, a target message including a malicious ad, the system comprising at least one processor and non-transitory computer-readable medium, storing executable instructions, which, when executed by the at least one processor, cause the system to:
during a first phase:
acquire, from online platforms, a plurality of training messages;
generate, for a given training message of the plurality of training messages, a respective message vector;
generate a training set of data including a plurality of training digital objects, a given one of which includes: (i) the respective message vector of the given training message;
and (ii) a respective label representative of the given training message being one selected from the group consisting of: a target message; and a non-target message;
feed, to a given prediction model of a plurality prediction models, the given training digital object, thereby training the given prediction model to generate a respective prediction of whether a given in-use message is a target one or not;
generate, based on respective predictions of the plurality prediction models, a respective training consolidated probability vector for the given training message of the plurality of training messages;
use respective training consolidated probability vectors associated with the plurality of training messages, training a decision tree model to determine whether the given in-use message is a target one or not;
during a second phase, following the first phase:
acquire, from the online platforms, the given in-use message;
generate, for the given in-use message, a respective in-use message vector;
feed, the respective in-use message vector, to each prediction model of the plurality trained models, thereby causing each one of the plurality prediction models to generate a respective probability value of the given in-use message being a target message;
generate, based on the respective probability values of the plurality prediction models, an in-use consolidated probability vector;
feed the in-use consolidated probability vector to the decision tree model, thereby causing the decision tree model to generate a final probability value of the given in-use message being a target message;
in response to the final probability value being representative of the given in-use message being a target message, cause execution of a remedial action.
